(19) United States
(12) Patent Application Publication
(10) Pub. No.: US 2026/0188912 A1
(43) Pub. Date: Jul. 2, 2026

(54) SYSTEM OF AND METHOD FOR DESIGNING REFLECTOR ARRAY FOR VEHICLE LOCALIZATION

(71) Applicant: Hitachi Rail GTS Canada Inc., Toronto (CA)

(72) Inventors: Mohamed HELWA, Toronto (CA); Calen IRWIN, Toronto (CA); Jaewook JUNG, Toronto (CA); Robert ADAM, Toronto (CA); Alon GREEN, Toronto (CA); Veronica MARIN, Toronto (CA); Philip CHRISTIAN, Toronto (CA)

(73) Assignee: Hitachi Rail GTS Canada Inc., Toronto (CA)

(21) Appl. No.: 19/435,476

(22) Filed: Dec. 29, 2025

Related U.S. Application Data
(60) Provisional application No. 63/740,165, filed on Dec. 30, 2024.

(51) Int. Cl. H01Q 15/14; G01S 13/75

(52) U.S. Cl. CPC H01Q 15/141; G01S 13/75

(57) ABSTRACT

A method of designing a reflector array for high integrity localization is disclosed. The method includes: defining a boundary of one or more localization regions; determining a number and location of unique reflector arrays; establishing a set of candidate reflector arrays; determining a subset of detectable reflector arrays of the candidate reflector arrays; verifying detectability over time of the subset of detectable reflector arrays; determining the subset of detectable reflector arrays that are robustly unique under sensor errors and/or reflector perturbations; and determining whether a sufficient number of detectable and unique reflector arrays have been established.

### BACKGROUND

Accurate localization of vehicles traveling on dedicated guideways enables safe and efficient operation in ground transportation systems. High-integrity positioning supports functions such as platform alignment, obstacle detection, and track discrimination, particularly in complex environments with multiple parallel tracks or regions where precise vehicle location provides advantages.

Other approaches used by ground transportation systems often face challenges in achieving reliable and cost-effective localization, especially in areas where environmental conditions or operational constraints limit the effectiveness of conventional technologies. The need for robust, streamlined solutions that provide high-accuracy positioning without extensive infrastructure or frequent maintenance is useful as transportation networks evolve.

Train position (localization) is typically determined using a transponder interrogator installed on-board the train and transponder tags installed along the track. Other solutions, such as Ultra-wideband (UWB) tags and anchors, are common in existing systems. These solutions require installation of RFID transponder interrogator or UWB anchors along the wayside in localization regions. In some cases (e.g., UWB anchor) the installed wayside object is active and needs plug-in power.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a high-level diagram of a method of design and verification of reflector array arrangement, in accordance with some embodiments.

FIG. 2 is a diagram of reflector locations in a 3D volume, in accordance with some embodiments.

FIG. 3 is a diagram of a simulation of parallel curved tracks and a reflector array, in accordance with some embodiments.

FIG. 4 is a diagram of reflector locations, in accordance with some embodiments.

FIG. 5 is a block diagram of a processing system according to one or more embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The disclosure is in the technical domain of Communication Based Train Control (CBTC), particularly autonomous trains. The disclosure focuses on determining the train position (localization) with high integrity and high accuracy using imaging radar. In particular in at least one embodiment, the disclosure proposes a novel design methodology of a set of passive radar reflectors, denoted herein as a reflector array, to be used as a landmark object for localizing the train. Localizing the train includes resolving the train track in a multi-track segment of the guideway without any ambiguity, denoted as a track discrimination problem, as well as determining the train location on the specified track, with high accuracy of a few centimeters level. The disclosure is also applicable to localizing engineering vehicles, work trains or another type of vehicle moving on a defined path. The disclosure is also generalizable to other sensor technologies beyond imaging radar, such as light detection and ranging (LiDAR) or cameras or infrared sensors, and the novel design methods herein are considered part of the disclosure even if it is applied to other sensor technology.

Accurate localization of trains using the proposed method according to an embodiment is not necessarily performed continuously, but at distinct regions of interest of the guideway where more accurate position is needed (for example, at platforms or near level crossing & switches). These regions are hereby denoted as localization regions. Positioning in-between localization regions is determined using dead reckoning algorithms. Although, in at least one embodiment, continuous localization using the proposed method is performed.

Accurate positioning at localization regions (down to centimeter level) is useful for running services such as platform alignment, obstacle detection and signal aspect recognition. For example, accurate train position is typically needed to determine an accurate movement authority region ahead of the train for obstacle monitoring especially in curved track regions or near switches, or to distinguish which of the signals ahead is the signal associated to the track of the train under consideration when in multi-track segments of the guideway.

Accurate and high-integrity vehicle localization is used in modern ground transportation systems, particularly for autonomous and safety-sensitive applications such as Communication-Based Train Control (CBTC). Existing localization methods, including transponder-based systems, Ultra-Wideband (UWB) anchors, and Global Navigation Satellite Systems (GNSS), face notable limitations. These include the need for dense installation of on-track or wayside objects, high maintenance costs, reliance on active infrastructure requiring power, and insufficient accuracy for applications like platform alignment or track discrimination in multi-track environments. Scene-based localization methods using vision sensors, such as LiDAR or cameras, have been proposed but encounter challenges such as lack of robustness to environmental variations, difficulty in maintaining and updating reference databases, computational inefficiency, and limited focus on integrity and safety certification. Furthermore, existing solutions often fail to provide systematic methodologies for ensuring the distinctiveness and detectability of landmarks under real-world conditions, including sensor errors, occlusions, and environmental perturbations.

One or more embodiments according to the present disclosure addresses these issues by introducing a novel design methodology for three-dimensional (3D) passive reflector arrays tailored for high-integrity vehicle localization using imaging radar. Unlike conventional approaches, the proposed solution leverages passive radar reflectors, eliminating the need for active infrastructure and reducing installation and maintenance costs. The disclosed methodology ensures robust and reliable localization by systematically designing reflector arrays that are compact, detectable with high confidence over the desired detection range, and distinguishable even under sensor errors or environmental changes. A simulation environment is employed to verify the detectability and distinctiveness of the reflector arrays across various guideway topologies, including curved and sloped tracks, ensuring consistent performance in complex operational scenarios. Additionally, one or more embodiments according to the disclosure incorporate temporal tracking and interpretable object-matching features, enhancing robustness against false detections and enabling seamless integration into safety-sensitive rail applications. By addressing the shortcomings of conventional solutions, one or more embodiments of the disclosure provide a cost-effective, scalable, and high-integrity approach for vehicle localization in modern transportation systems.

Other approaches known to the inventors have one or more of the following difficulties.
1. Require dense installation of on-track or wayside objects within the localization regions for transponder tags and UWB, respectively. This, in turn, leads to increased cost of the solution and its maintenance.
2. On-track equipment, e.g., transponder tags, are difficult and/or expensive to maintain.
3. In some solutions (such as UWB) the installed infrastructure objects are active, which require securing power to them using extensive guideway cabling and requiring more regular maintenance as well.
4. Localization accuracy may not meet the accuracy requirements for platform alignment (typically 10 cm or less). For example, transponders have a typical footprint of 1-2 m.

Localization may be also performed using the Global Navigation Satellite System (GNSS). However, localization accuracy is typically worse than the desired accuracy level of a few centimetres, and GNSS is not always available underground (e.g., in subways and tunnels).

Other approaches have been developed to localize trains by comparing the perceived scene, using an on-board vision sensor (e.g., LiDAR or camera or radar), to stored scene information contained in an offline database. In accordance with another method, a 3D image captured by LiDAR installed on a vehicle on a pathway is received, transformed from a 3D image into a 2D image, and determines a location of the vehicle along the pathway by comparing the 2D image to a plurality of 2D images-each captured at a respective known location along the pathway, using classical computer vision techniques. While the foregoing example compares raw, simple features extracted using automated feature extraction applied to raw sensor data (feature matching), other approaches use higher-level object matching, where complex objects with high-level characteristics are detected and matched based on the collection of characteristics. Other approaches may use a single vision sensor, or a variety of vision sensors.

The other approaches suffer from the following one or more general problems.
1. Lack of focus on integrity of the position measurement for scene-based localization methods: This may include lack of consideration of safety principles or supervisions or the incorporation of trustable information (e.g., safety integrity level (SIL) 4 vehicle speed) in the monitoring or verification of the processing. In some cases, other approaches focus on the performance (e.g., accuracy) of the localization rather than the integrity (trustworthiness). In some cases, the use of probabilistic filtering can introduce significant challenges for provable integrity/safety certification just as the incapability of justifying non-realistic assumptions on the type of signal distributions.
2. Lack of interpretable matching features, particularly when using feature matching approaches: Some other approaches rely on matching features between reference data and current onboard sensor data (i.e., feature matching), and in some cases these features are extracted using automated feature extraction algorithms (e.g., SIFT, SURF in 2D). Comparing images using automated feature extraction and computer vision algorithms lacks interpretable definition of features for comparison, and hence, the found localization solution is difficult to interpret or justify. The resulting reference database/maps are also more difficult to validate than one or more of the present embodiments.
3. Lack of temporal tracking of scene information: Rail guideway environments (in particular, underground tunnel sections) typically have repeatable patterns of some objects (e.g., pillars), and one instance of captured data by on-board sensors may not be enough to identify the unique location on the guideway. These situations may be handled by a fusion/amalgamation of sensor data over a temporal window, the construction of a temporally-and/or spatially-local map, or the ability of the system to ‘dead-reckon’ (operate with landmarks) for an extended period of time. As well, the vehicle may need to travel for some distance beyond the field of view of the used sensor technology to collect enough scene features to uniquely identify the scene and hence the location of the vehicle within the guideway.
4. Non-robustness against sensor variation, scene changes & various environmental conditions: Stored data in a particular scene's condition may not be suitable for comparison with data captured online in a different scene condition. For example, a neighboring train may occlude a considerable portion of the infrastructure objects in the scene leading to poor matching, or objects may be perceived differently from the onboard sensor in poor weather or lighting conditions as compared to ideal weather & lighting conditions. Storing database images for all the possible scene scenarios may not be feasible. In cases where feature matching of raw data is used, and where the reference map is built from raw data from a different sensor that may be in a different location on the vehicle, a transformation must be applied to transform the current sensor data to the reference data, or vice versa, and this transformation can be error-prone and difficult to validate.
5. Lack of verification method for uniqueness of scene: Other approaches do not provide a method to verify that scene images stored in the database are dissimilar enough to uniquely identify the position on the guideway. The risk is that (even small) detection errors of an onboard sensor may lead to wrong matching to a similar image in a different region of the guideway resulting in a wrong vehicle position and consecutive safety hazards.
6. Difficulty of maintaining/updating the database: Because the database contains images and not modular information of objects, any minor change to even one feature of one object in the scene (e.g., location of a sign) may require full update of the localization region images in the database. This process can be lengthy and expensive.
7. Computationally expensive methods: Comparing raw data (e.g., in feature matching approaches) is more computationally expensive than comparing individual characteristics of selected objects, and may not be feasible to run in real time. While one can argue the possibility of using a large number of parallel processors, this leads to increased cost of the solution.

One or more of these problems may be overcome in one or more embodiments according to the present disclosure.

In another approach, a localization method has been invented to resolve the aforementioned problems in other approaches using a multi-sensor system onboard the train, coupled with landmark objects for object matching. These landmark objects include natural landmark objects, which are pre-existing objects along the guideway. Examples include, but are not limited to, signs, signals, poles, and electric boxes. They also include for-purpose landmark signs added for the purpose of localization. Nevertheless, the other approach did not provide a methodology for designing those for-purpose landmarks to ensure detectability by the onboard sensors, uniqueness over the localization region of interest, nor reliability under various environmental/operational conditions. In accordance with one or more embodiments of the present disclosure, we provide a novel and detailed methodology for the design of a for-purpose landmark object for 4D imaging radar sensor technology. This includes novel methodologies for verifying the detectability and for verifying the uniqueness of the landmark object/objects.

Imaging radar has a better robustness against adverse weather conditions, poor lighting conditions, and contaminated sensor surfaces (e.g., dust) as compared to LIDAR and camera sensor technologies. Imaging radars also provide Doppler speed information of objects which can be used to supervise that detected landmark objects are “stationary” with the aid of a trustable vehicle velocity from a SIL 4 odometry function running onboard the vehicle.

Approaches of localization using radar reflectors/reflective material can be found in the open literature. While these papers use reflectors/reflective material for localization, the papers do not mention or study high integrity localization. In particular, the papers do not study/mention how to design a reflector array of a set of reflectors for ensuring uniqueness of the reflector array with respect to other reflector arrays or other existing objects or false/ghost reflections for avoiding wrong matching to another reflector array and hence avoiding wrong localization. Also, there is no description of how to design a reflector array as the focus is on how to solve the location from the reflectors. Moreover, there is no methodology provided to ensure persistent detectability (with confidence) of all reflectors in the reflector array from all ranges of interest and over the speeds of vehicle operation of interest.

One or more embodiments according to the present disclosure resolves one or more of the aforementioned issues by providing the following:
1. A novel 3D passive reflector array design based on a systematic methodology for ensuring compact size within a predefined maximum volume, detectability of the reflector array with confidence by the imaging radar over the detection range of interest, and uniqueness of the reflector array even under detection errors and/or failures.
2. A novel methodology for verifying the detectability of ALL reflectors in the reflector array from different intended tracks and over the detection range of interest; the methodology is based on a designed simulation environment of multi-track segments and is valid for curved and sloped track segments of the guideway.
3. A novel methodology for verifying the uniqueness of the reflector array over the position search region even under sensor detection errors or failures/changes to the array.

In particular, the localization problem is resolved by first using a coarse position input, entitled herein a ‘position bubble.’ The position bubble limits the position search region to a particular localization region related to the coarse position bubble. Examples of coarse position inputs include but are not limited to radio positioning, GPS/GNSS position, and verified human (rough) position input. Then, within the coarse position bubble, the accurate position (edge, offset) and orientation are determined using the imaging radar and the novel passive radar reflector array proposed in this disclosure.

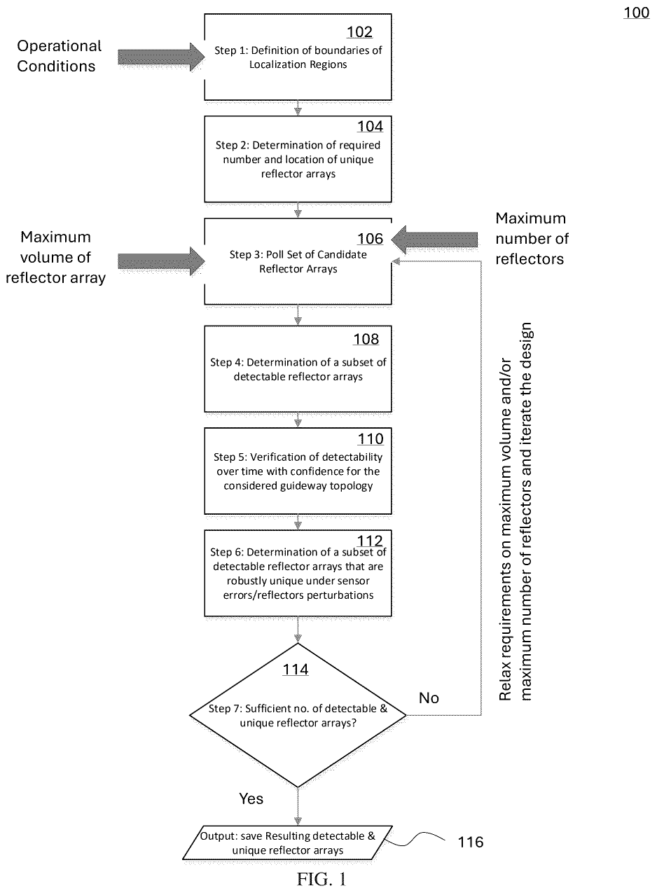

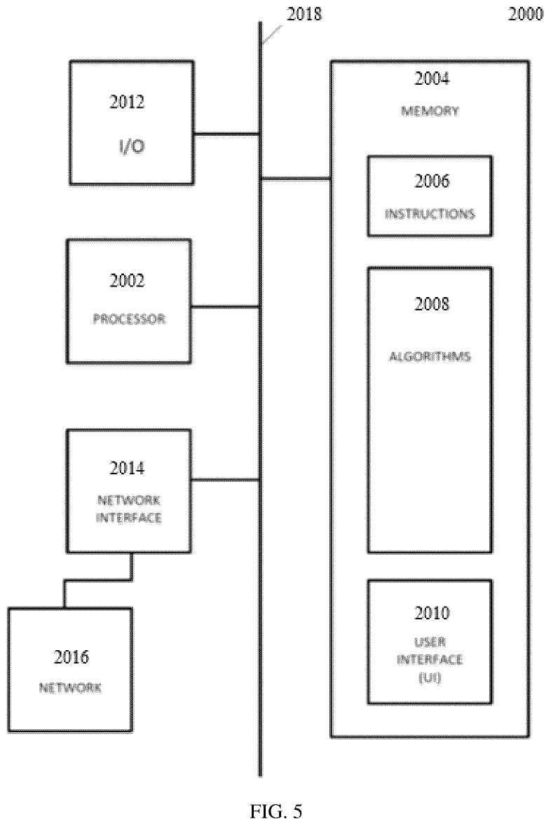

FIG. 1 is a high-level diagram of a method of design and verification of reflector array arrangement, in accordance with some embodiments. A processing system, e.g., processing system 2000 (FIG. 5), is configured to execute a set of instructions for performing the method of FIG. 1. A brief description is provided below for each step of the process. The process flow begins at process 102.

### Process 102: Definition of Boundaries of Localization Regions

In this step, boundaries of the localization regions are specified by the users or client services that specify regions of the guideway where accurate position is useful (e.g., at platform entrances or near switches). Additional operational conditions can also be used as an input for refining the definition of the localization regions. This includes definitional inputs such as at what distance from the start of localization region boundary the accurate position is needed, or how many times/cycles the localization function needs to localize based on the landmark in the localization region for initializing or updating the position of the vehicle, among others. In some embodiments, the operation conditions include vehicle speed or velocity, vehicle acceleration, and/or vehicle jerk. The process flow proceeds to process 104.

### Process 104: Determination of Required Number and Location of Unique Passive Reflector Arrays

For each localization region, a set of unique reflector arrays is defined. The number of unique reflector arrays needs to consider the following factors:
1. Plausible Train Orientation - reflectors are typically unidirectional, and hence, reflector arrays are designed to be detectable from a particular orientation. Therefore, if both train orientations are plausible, a reflector array is needed for each orientation. The two reflector arrays need to be distinguishable from each other in order to be able to distinguish the orientation.
2. Number of parallel tracks in the localization region - The higher the number of tracks, the more reflector arrays may be needed for localization.
3. Clear line of sight to reflector arrays: While the angle of arrival (AoA) of imaging radar is usable to distinguish the train track from among multiple tracks, practical situations of blocking the line of sight to the reflector arrays may happen, and need to be accounted for in specifying the number of reflector arrays in multi-track segments for ensuring clear line of sight. For example, a wayside reflector array on the extreme right or extreme left of multi-track segments may not be detectable from the middle tracks due to blockage by neighboring trains or in situations where there are walls or pillars separating multiple tracks.

Hence, the number of reflector arrays may vary from two reflector arrays for the cases where clear line of sight is ensured from all tracks to a worst case of 2*n, where n is the number of parallel tracks in the multi-track segment. In some embodiments, the worst case may be larger than 2*n based on simulations considering parameters such as headway, vehicle speed or velocity, vehicle length (e.g., number of cars in a consist), and/or vehicle acceleration. In some embodiments, the number of parallel tracks in the segment and whether solid dividing walls are between the sets of parallel tracks is considered in addition to visual inspection of the guideway.

The location of the reflector array is decided in this step to ensure clear line of sight to the target reflector array. In one embodiment of this disclosure, a reflector array is placed next to each track for ensuring clear line of sight to the arrays resulting in 2*n reflector arrays per localization region. In one embodiment of the disclosure, a reflector array is placed in-between each pair of parallel tracks resulting in 2*(n-1) reflector arrays per localization region. In another embodiment of the disclosure, only two reflector arrays are placed at the extreme left/right sides of the multi-track segments at sufficiently high height to not be blocked by neighboring trains. Another combination of reflector array locations resulting in a clear line of sight to the reflector array is part of this disclosure. In some embodiments, the locations are determined based on one or more parameters including headway, vehicle speed or velocity, vehicle length (e.g., number of cars in a consist), vehicle acceleration, sensor on vehicle height above the ground plane, the reflector array height above the ground plane, the vehicle height above the ground plane, the grade of the track segment, and/or clear line of sight from the vehicle to the reflector array. The process flow proceeds to process 106.

### Process 106: Definition of a Set of Candidate Reflector Arrays

During this process, a set of candidate reflector arrays is defined considering the maximum possible size or volume of the reflector array and the maximum number of reflectors required per array.

Starting from the maximum allowed size of the reflector array defined in X, Y and Z distances, a grid of possible locations of the reflectors in the reflector array is defined. In at least one embodiment, a constraint on a size of the reflector array includes the physical volume available for the reflector array, the minimum individual reflector size detectable by the radar, and the radar discrimination capability between reflectors. An example of a size constraint includes a clearance between a vehicle and walls, bridges, or other structures near the track segment. An example of a maximum allowed size of a reflector array is 1 meter (m)×0.6 m×1 m. In this example, the maximum lateral extension of 0.6 m considers the clearance required between two trains on two adjacent tracks, in order to not interfere with train operation. The array grid size is a configurable parameter. In one embodiment of the disclosure, the grid size is selected as a multiplier factor (XX_grid_size_multiplier) of the range resolution of the imaging radar, where the multiplier factor (XX_grid_size_multiplier) is greater than 1. This selection helps the imaging radar distinguish the two reflectors in the two grid locations through the different ranges to the reflectors. As an example, the multiplication factor can be selected equal to 2, i.e., if the range resolution of a radar is 10 cm, then the grid size is 20 cm and so on. For each embodiment of this disclosure, the configuration parameter for the grid size may vary in one or each of the three X, Y, Z directions.

Based on the considered number of reflectors in the array, limited to be less than or equal to the maximum allowed number of reflectors, the set of combinations of plausible candidate reflector arrays is defined.

For example, the maximum number of reflectors can be selected initially by a user to be 5, the number may be defined based on cost considerations. If the reflectors are defined with 20 cm grid step in the above 3D 1 m×0.6 m×1 m volume and leaving 10 cm tolerance from each side in the 3D volume to account for the reflector size, we have the following slots in longitudinal 10, 30, 50, 70 and 90 cm (5 slots), in lateral 10, 30, 50 cm (3 slots) and in height 10, 30, 50, 70 and 90 cm (5 slots). This results overall in 5×3×5=125 available slots for placing the reflectors. The set of combinations for placing the 5 reflectors in the 125 available slots is: C(125,5)=2.34*10\hat{ }8 possibilities, where C(.,.) is the combinatorial operator. The user can also select to place less reflectors, e.g., 4 reflectors, which will give additional possibilities of C(125,4)=9.69*10\hat{ }6 options for placement of the reflectors in the array.

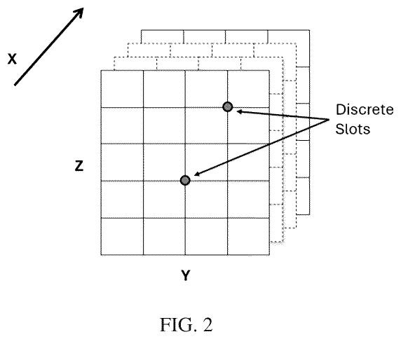

FIG. 2 is a diagram of reflector locations in a 3D volume, in accordance with some embodiments, and illustrates the concept of a 3D reflector array and how the 3D volume is partitioned into a grid of possible locations. The possible locations are plotted in the Y-Z plane orthogonal to the X direction in which the vehicle would be moving.

FIG. 2 shows a three-dimensional grid representing a predefined bounding volume partitioned into discrete slots for potential reflector locations. This grid is utilized in the design methodology for passive reflector arrays, enabling systematic placement and evaluation of radar reflectors within a constrained spatial envelope.

The discrete slots are defined within the grid along three axes: X, Y, and Z. The X axis represents the longitudinal direction, typically aligned with the guideway or track. The Y axis corresponds to the lateral direction, which is perpendicular to the track and accounts for the clearance between adjacent tracks or vehicles. The Z axis represents the vertical direction, allowing for height variations in the placement of reflectors. Together, these axes form a structured three-dimensional space where each slot corresponds to a potential location for a radar reflector.

The grid is configured based on operational requirements, such as the maximum allowable dimensions of the reflector array and the resolution capabilities of the imaging radar. For example, the spacing between discrete slots in each axis may be determined as a multiple of the radar's range resolution, ensuring that reflectors placed in adjacent slots are distinguishable by the radar. This configuration supports the design of compact reflector arrays that are detectable with high confidence over the intended detection range.

Each discrete slot within the grid serves as a candidate location for placing a radar reflector. The systematic partitioning of the bounding volume into discrete slots enables the generation of a large set of candidate reflector arrays, which can then be filtered and evaluated for detectability and distinctiveness. This approach ensures that the reflector arrays meet the requirements for reliable localization, even under varying environmental conditions and sensor errors.

The three-dimensional grid illustrated in FIG. 2 serves as an integral part of the described system, as it provides a structured framework for designing reflector arrays that are both compact and robust. By discretizing the bounding volume into discrete slots, the described system enables a systematic approach to exploring reflector configurations, reducing reliance on experimental trial-and-error methods and supporting efficient optimization of the array design.

In the following processes, a subset of those candidate arrays is to be defined to ensure detectability by the imaging radar persistently over the range of interest as well as uniqueness of the reflector arrays with respect to each other even under sensor errors and/or perturbations in reflector positions. Returning to FIG. 1, the process flow then proceeds to process 108.

### Process 108: Determination of a Subset of Detectable Reflector Arrays

During process 108, the set of candidate reflector arrays determined in process 106 is filtered to reject the candidates whose reflectors are unlikely to be detectable by the imaging radar, e.g., in some embodiments the imaging radar is a commercial off-the-shelf (COTS) imaging radar.

In particular, for the imaging radar to distinguish two stationary objects close to each other, e.g., two reflectors, the radar should be able to resolve the two objects in either range, azimuth angle or elevation angle. Otherwise, the two objects will be seen by the radar as a single object preventing the capability of detecting the full pattern of reflectors in the reflector array.

However, doing the full check of detectability is challenging since the location of the radar varies leading to varying range, azimuth angle and elevation angle as the vehicle moves. To resolve this challenge, we assume in this process that the longitudinal extension of the reflector array is a direct indication of range value, the lateral extension of the reflector array is a direct indication of azimuth angle, and the vertical extension of the reflector array is a direct indication of elevation angle. These assumptions are valid for straight tracks for which the reflector array longitudinal direction is parallel to the track. This simplification allows us to reject some candidates out of the large combinations from process 106, and then in process 110 verification of detectability will be carried out more precisely considering the geometry of the guideway segment in the localization region (e.g., curves, sloppy grade). Also, the assessment of detectability in this step is typically carried out at a desired maximum detection distance from the reflector array (XX_max_long_detection_range), while in the next process verification of detectability of remaining candidates happens at various detection distances of interest. The parameter (XX_max_long_detection_range) is set based on operational requirements, and an example of its value is 30 m. In some embodiments, larger or smaller values of the parameter (XX_max_long_detection_range) are usable.

Hence, during process 108, a candidate reflector array is kept if each pair of reflectors in the array satisfies at least one of the following conditions. Otherwise, the candidate reflector array is rejected.
1. The difference between longitudinal locations of the two reflectors in the array is greater than a multiplication factor (XX_factor_long) of the range resolution of the radar sensor. The multiplication factor (XX_factor_long) is a configuration parameter and should be selected greater than or equal to 1. Examples of possible values include but are not limited to 1 or 1.5 or 2.
2. The difference between lateral locations of the two reflectors in the array is greater than a multiplication factor (XX_factor_lat*XX_max_long_detection_range*tan(azimuth resolution of the radar sensor)). The multiplication factor (XX_factor_lat) is a configuration parameter and should be selected greater than or equal to 1. Examples of possible values include but are not limited to 1 or 1.5 or 2.
3. The difference between vertical locations of the two reflectors in the array is greater than a multiplication factor (XX_factor_ver*XX_max_long_detection_range*tan(elevation resolution of the radar sensor)). The multiplication factor (XX_factor_ver) is a configuration parameter and should be selected greater than or equal to 1. Examples of possible values include but are not limited to 1 or 1.5 or 2.

The process flow then proceeds to process 110.

### Process 110: Verification of Detectability of Reflector Array Over Time With Confidence for the Considered Geometric Topology

During process 110, the subset of reflector arrays from process 108 are further examined for detectability considering the guideway topology (e.g., curvature, grade) in the localization region. To that end, a novel methodology for verifying the detectability of all reflectors in the reflector array from different intended tracks and over the detection range of interest is disclosed. The methodology is based on a designed simulation environment of multi-track segment and is valid for curved and/or inclined track segments of the guideway.

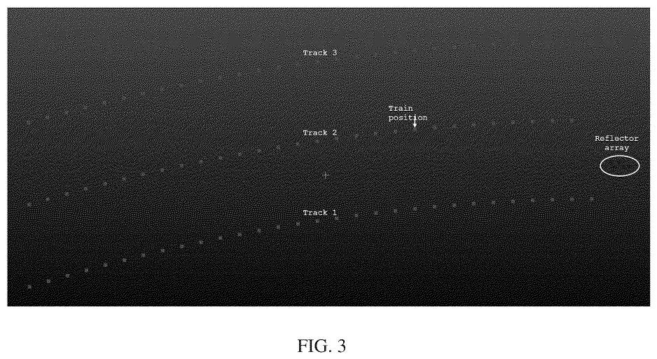

In particular, the simulator allows the designer to define multi-track segments emulating the localization region, specify the location of the reflector array, define the detailed structure of the candidate reflector array, and specify the intended tracks for detection of the array as well as desired minimum and maximum detection ranges to the reflector array. Then, the simulator discretizes the splines of the intended tracks into discrete check points between maximum and minimum detection ranges. The discretization step is a configuration parameter of the simulator. An example of a valid value of the step is 0.25 m. FIG. 3 is an example of the output of the simulation environment for a localization region of three parallel curved tracks.

FIG. 3 shows a schematic representation of train localization using a passive reflector array across multiple tracks. The figure illustrates a multi-track guideway comprising Track 1, Track 2, and Track 3, along which a train is positioned. The train position is depicted as being on Track 2, and the localization process is facilitated by a reflector array positioned adjacent to the tracks.

The reflector array is designed to provide a distinct and detectable spatial pattern for imaging radar mounted on the train. The reflector array is positioned to ensure a clear line of sight from the train's radar system, facilitating precise detection and identification of the array. This placement is for determining the train's position and track assignment, particularly in multi-track segments where ambiguity in track discrimination may arise.

The reflector array interacts with the imaging radar by reflecting the emitted radio-frequency signals back to the radar, forming a three-dimensional radar point-cloud. The spatial arrangement of the reflectors within the array is designed to be distinguishable and identifiable, even under conditions of sensor errors or environmental perturbations. This ensures robust and high-integrity localization of the train.

The schematic also highlights the importance of the reflector array's placement relative to the tracks. The array is positioned to maintain detectability from all intended tracks within the localization region. This configuration accounts for potential obstructions, such as neighboring trains or infrastructure elements, ensuring that the radar can reliably detect the array from various angles and distances.

The train's imaging radar processes the reflected signals to identify the reflector array and correlate the detected position with pre-stored georeferenced map data. This facilitates accurate determination of the train's location and track, supporting functions such as platform alignment, obstacle detection, and track discrimination in complex multi-track environments.

FIG. 3 demonstrates the integration of a passive reflector array with an imaging radar system for high-accuracy train localization. The arrangement of the tracks, train, and reflector array exemplifies the system's ability to resolve the train's position with high integrity, even in challenging multi-track scenarios.

Returning to FIG. 1 and process 110 then, at each discrete location of the spline, a test is performed to check whether all the reflectors in the reflector array are detectable from the discrete location on the intended track. The reflector array passes the test at a particular discrete location if each pair of reflectors in the array satisfies at least one of the following conditions:
1. The difference between the ranges from the discrete location to the two reflectors in the array is greater than a multiplication factor (XX_factor_sim_range) of the range resolution of the radar sensor. The multiplication factor (XX_factor_sim_range) is a configuration parameter and should be selected greater than or equal to 1. Examples of possible values include but are not limited to 1 or 1.5 or 2.
2. The difference between the azimuth angles from the discrete location to the two reflectors in the array is greater than a multiplication factor (XX_factor_sim_azimuth) of the azimuth resolution of the sensor. The multiplication factor (XX_factor_sim_azimuth) is a configuration parameter and should be selected greater than or equal to 1. Examples of possible values include but are not limited to 1 or 1.5 or 2.
3. The difference between the elevation angles from the discrete location to the two reflectors in the array is greater than a multiplication factor (XX_factor_sim_elevation) of the elevation resolution of the sensor. The multiplication factor (XX_factor_sim_elevation) is a configuration parameter and should be selected greater than or equal to 1. Examples of possible values include but are not limited to 1 or 1.5 or 2.

The simulator also allows the user to define an acceptance criterion for keeping a reflector array to satisfy a certain confidence level of persistent detectability over time. For example, the user can specify how many consecutive discrete locations need to pass the aforementioned test for not rejecting the reflector array. In one embodiment of the disclosure, the reflector array is kept if the array is persistently detectable from a parameter for the number of consecutively passed discrete locations (XX_no_cons_passed_discrete_locations) (e.g., 10 locations). In one embodiment of the disclosure, the reflector array is kept if the reflector array is detectable more than a number of passed discrete locations (XX_no_passed_discrete_locations) in a set of number of tested discrete locations (XX_no_tested_discrete_locations). Examples of values of (XX_no_passed_discrete_locations) and (XX_no_tested_discrete_locations) are 15 and 20, respectively. In one embodiment of the disclosure, the parameters (XX_no_cons_passed_discrete_locations) or (XX_no_passed_discrete_locations) are selected to enforce a certain confidence level of the detector tracker. Examples of a tracker include but are not limited to Kalman filters and particle filters. In one embodiment of the disclosure, the confidence level of the tracker is usable to provide integrity on the detection and hence on the calculated position from the reflector array. The process flow then proceeds to process 112.

### Process 112: Determination of a Subset of Detectable Reflector Arrays That are Robustly Unique Under Sensor Errors/Reflector Perturbations

During process 112, the subset of reflector arrays from process 110 is examined for uniqueness with respect to each other under sensor and/or reflector perturbations.

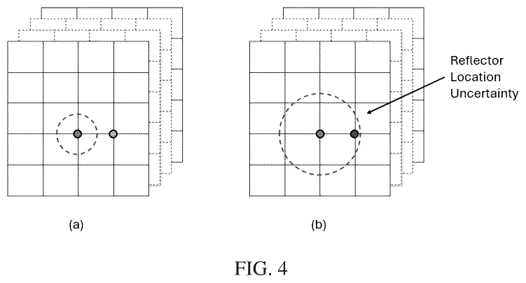

While each reflector array in the set is different from any other reflector array by construction (process 106), the uniqueness of an array may be violated and the reflector arrays may become undistinguishable under sensor errors or reflector changes. For example, the range, azimuth angle and/or elevation angle to a reflector in the reflector array will have errors in practice such as random accuracy errors, numerical granularity/rounding errors, and installation errors, which may result in a wrong determination of the reflector location in the set of discrete slots of the reflector array (see FIG. 4). If the slot in the array is incorrectly determined by the detector due to those errors, then the detector pipeline may incorrectly match the detected reflector array (with erroneous reflector location) to another reflector array in the set of reflectors from process 110.

FIG. 4 is a schematic representation of reflector location uncertainty within a grid of possible reflector positions. FIG. 4 includes two scenarios: (a) a case where the reflector location uncertainty does not intersect with neighboring reflector slots, and (b) a case where the reflector location uncertainty intersects with neighboring reflector slots.

In scenario (a), the reflector location uncertainty is confined within a boundary that does not overlap with adjacent slots in the grid. This configuration ensures that the reflector's position remains distinguishable from other potential reflector positions within the grid. Such a setup is used for preserving the integrity of the reflector array's spatial pattern, as it reduces the risk of misidentification due to positional errors or perturbations.

In scenario (b), the uncertainty in the reflector's location extends beyond the designated slot and intersects with neighboring slots in the grid. This overlap introduces ambiguity regarding the reflector's position, potentially resulting in incorrect identification of the reflector array. Positional uncertainty can stem from factors such as sensor measurement errors, environmental conditions, or installation inaccuracies. The intersection with neighboring slots underscores the usefulness of robust design methodologies to address the effects of such uncertainties.

The reflector location uncertainty depicted in FIG. 4 highlights the systematic verification of reflector array designs to ensure consistent detectability and reliable distinctiveness. By accounting for potential positional errors and ensuring that the spatial signature of the reflector array remains identifiable, the described system addresses challenges associated with accurate localization in complex environments.

Returning to FIG. 1 and process 112, as another example, if the location of one or more reflectors in the reflector array is changed, then the new locations of the reflectors in the array may resemble another reflector array. For instance, one reflector may move a little from its location due to adverse environmental conditions.

To resolve those challenges, we are imposing some robustness in the design of the reflector array patterns. In particular, in comparing the similarity between two reflector arrays from the subset of arrays from process 110, we consider the two reflector arrays to be similar if:
1. There is a subgroup of a minimum number of matching (XX_min_reflectors_matching) reflectors with the same features (e.g., shape/size) and pattern in the two reflector arrays. The parameter (XX_min_reflectors_matching) is a configuration parameter and is selected to enforce a desired hamming distance in the design, i.e., the parameter sets the maximum number of allowed changes in the features/locations of reflectors in the array to make the two reflector arrays identical, and hence, non-distinguishable from each other. For example, suppose that we have two reflector arrays each of which has 5 reflectors. Selection of (XX_min_reflectors_matching) to be 3 means that we may accept that the two reflector arrays have a sub-matching of 2 reflectors or less for being distinguishable. This will enforce a hamming distance of 3, i.e., the two reflector arrays with sub-matching of 2 reflectors will require 3 changes in one of the reflector arrays (e.g., movement of 3 reflectors) to make the reflector array identical to the other reflector array.
2. The sensor range, azimuth angle and/or elevation angle errors can lead to wrong locations of the reflectors of one reflector array such that the new locations are similar to the locations of the reflectors of the other array. This can be checked for a candidate reflector array by simulating the effect of the range, azimuth angle and/or elevation angle errors at different locations of the tracks with the aid of the simulator in process 110, and assessing the similarity against all of the reflector arrays from process 110. The reflector array is rejected if the reflector array is found similar to any other reflector array from process 110.
3. A combination of the above two conditions is satisfied. In one embodiment of the disclosure, a sub-similarity of (XX_min_reflectors_matching) reflectors after injection of range, azimuth angle and/or elevation angle errors is considered as similarity between arrays, and similar reflector arrays are rejected.

The remaining set of reflector arrays, after rejecting the similar ones, is considered to be the set of robustly unique arrays against sensor errors and/or reflector changes.

In one embodiment of the disclosure, the localization region is also surveyed for existing natural landmark objects Examples include but are not limited to signals, signs, electric boxes, poles, walls, platforms, platform edges/corners. Then, the reflection pattern of those objects as perceived by imaging radar is cross compared to the pattern of the reflector arrays to verify the uniqueness of the reflector arrays against those objects.

In another embodiment of the disclosure, the probability of having a random reflection pattern of radar ghost targets (e.g., from multi path) resembling the same pattern of a reflector array is calculated for one cycle or over multiple cycles in a time window, and then shown to be improbable. For example, the probability of generating one of the combinations out of the C(125,5) combinations in process 106 by chance is 1/C(125,5)=4.27*10\hat{ }−9. The probability from random reflections will be even lower if we request persistent detections in the temporal tracker. For example, requesting that the same pattern happens 5 times out of 10 cycles results in a much lower probability of the event making it an improbable one. For instance, assuming binomial distribution of independent events will result in probability of around 3.577*10\hat{ }−40 for this example. This makes our proposed solution suitable for SIL 4 high-integrity systems.

For a system to be rated as Safety Integrity Level (SIL) 4, the system is required to have demonstrable on-demand reliability, and techniques and measurements to detect and react to failures that may compromise the system's safety properties. SIL 4 is based on International Electrotechnical Commission's (IEC) standard IEC 61508 and EN standards 50126 and 50129. SIL 4 requires the probability of failure per hour to range from 10−8 to 10−9. Safety systems that are not required to meet a safety integrity level standard are referred to as SIL 0.

The process flow then proceeds to process 114.

### Process 114: Check Whether There are a Sufficient Number of Detectable & Unique Reflector Arrays

During process 114, the number of reflector arrays passing the uniqueness checks in process 112 is compared to the required number of unique reflector arrays in the localization region from process 104. If the number of unique reflector arrays from process 112 is less than the required number of unique reflector arrays from process 104, then a re-design iteration is needed and the flow returns to process 106. In some embodiments, instead of returning to process 106 an alert is generated and one or more input parameters are adjusted. Otherwise, we have a sufficient number of unique reflector arrays for the localization region and the set of unique arrays is output by the design process in process 116.

In one embodiment of the disclosure, the required number of unique reflector arrays in the considered localization region and in all adjacent localization regions are summed up to determine a total number of required unique reflector arrays. For this case, the number of designed reflector arrays passing process 112 is compared to the total number of required reflector arrays and not to the number of arrays per the localization region only. This enforces the designed reflector arrays in adjacent localization regions (not only in the same region) to be unique with respect to each other, and hence, larger coarse position bubble uncertainties can still be handled through the radar reflector landmark localization.

An advantage of one or more of the disclosed embodiments is that it allows the design of detectable, unique reflector array landmarks for high-integrity localization via a systematic way and without the need for experimental trial and error of different shapes of reflector arrays saving significant amounts of efforts and costs.

One or more embodiments according to the present disclosure resolve one or more of the aforementioned issues of existing solutions as follows:
1. In comparison to existing CBTC localization technology, one or more embodiments according to the present disclosure instead relies on passive reflective material which reduces the cost of installation and maintenance of on-track/active wayside objects compared to transponder tags and UWB solutions, respectively. In one or more embodiments, active reflectors or transponders are usable.
2. One or more embodiments provides high-integrity position based on using coarse position bubble and well-designed unique reflector arrays within the localization region, which is an advantage over several existing methods not designed to achieve high integrity.
3. In comparison with feature matching approaches (e.g., using comparison of captured images and automated feature extraction), one or more embodiments according to the present disclosure - incorporating higher-level object matching - utilizes interpretable features of the landmark objects that can be understood and justified by humans. This advantage, together with the previous one, makes one or more embodiments more suitable to be used for safety-critical rail applications.
4. One or more embodiments utilizes temporal tracking which reduces the impact of false sensor detections.
5. One or more embodiments provides a systematic approach for evaluating robust uniqueness of landmark objects, which informs the decision of whether more complex reflector arrays is needed for localization with no ambiguity. Existing scene-based positioning methods do not provide a systematic methodology for evaluating uniqueness of landmark objects.
6. Modularity of the landmark objects in accordance with one or more embodiments simplifies the process of map update for the case where few changes are happening to objects features (e.g., position update of one reflector array). On the other hand, existing methods based on comparison of images would require re-capturing full images of updated localization region even if the change happened to a single object feature.
7. One or more embodiments according to the disclosure is computationally efficient as the method only compares properly selected features of finite objects and not entire images or large image feature sets.
8. One or more embodiments according to the disclosure includes determining with high integrity the orientation of the train on the guideway as well, i.e., the guideway direction the sensor's field of view (FOV) is facing. This is an advantage over other scene-based positioning methods that do not provide orientation.

FIG. 5 is a block diagram of a processing system according to one or more embodiments.

One or more embodiments are implemented using a processing system 2000 of FIG. 9. In some embodiments, the processing system 2000 is, e.g., a general purpose computing device including a hardware processor 2002 and a non-transitory, computer-readable storage medium 2004. In some embodiments, the computer-readable storage medium 2004, amongst other things, is encoded with, i.e., stores, computer program code (or instructions) 2006, i.e., a set of executable instructions. In some embodiments, execution of computer program code 2006 by the processor 2002 implements a portion, or all, of the methods described herein accordance to one or more embodiments (hereinafter, the noted processes and/or methods).

In some embodiments, the processor 2002 is electrically coupled to the computer-readable storage medium 2004 via a bus 2018. In some embodiments, the processor 2002 is also electrically coupled to an I/O interface 2012 by the bus 2018. In some embodiments, a network interface 2014 is also electrically connected to the processor 2002 via the bus 2018. In some embodiments, the network interface 2014 is connected to a network 2016, and the processor 2002 and the computer-readable storage medium 2004 connect to external elements via the network 2016. In some embodiments, the processor 2002 is configured to execute the computer program code 2006 encoded in the computer-readable storage medium 2004 in order to cause the processing system 2000 to be usable for performing a portion or all of the noted processes and/or methods. In some embodiments, the processor 2002 is hardware, e.g., a central processing unit (CPU), a multi-processor, a distributed processing system, an application specific integrated circuit (ASIC), another suitable processing unit, or the like.

In some embodiments, the computer-readable storage medium 2004 is, e.g., an electronic, magnetic, optical, electromagnetic, infrared, and/or a semiconductor system (or apparatus or device). In some embodiments, the computer-readable storage medium 2004 includes, e.g., a semiconductor or solid-state memory, a magnetic tape, a removable computer diskette, a random-access memory (RAM), a read-only memory (ROM), a rigid magnetic disk, and/or an optical disk such as a compact disk-read only memory (CD-ROM), a rewritable compact disk (CD-R/W), and/or a digital video disc or digital versatile disc (DVD).

In some embodiments, the computer-readable storage medium 2004 stores the computer program code 2006 that is configured to cause the processing system 2000 to be usable for performing a portion or all of the noted processes and/or methods. In some embodiments, the computer-readable storage medium 2004 also stores information that facilitates performing a portion or all of the noted processes and/or methods. In some embodiments, the computer-readable storage medium 2004 stores information 2008 that includes, e.g., one or more algorithms or the like.

In some embodiments, the processing system 2000 includes an I/O interface 2012. In some embodiments, the I/O interface 2012 is coupled to external circuitry. In some embodiments, the I/O interface 2012 includes, e.g., a keyboard, keypad, mouse, trackball, trackpad, touchscreen, and/or cursor direction keys for communicating information and commands to the processor 2002.

In some embodiments, in the processing system 2000, the network interface 2014 is coupled to the processor 2002. In some embodiments, the network interface 2014 allows the processing system 2000 to communicate with the network 2016, to which one or more other computer systems may be connected. In some embodiments, the network interface 2014 implements wireless network interfaces such as BLUETOOTH, WIFI, WIMAX, GPRS, and/or WCDMA; and/or wired network interfaces such as ETHERNET, USB, and/or IEEE-1364. In some embodiments, a portion or all of noted processes and/or methods are implemented in two or more of the processing systems 2000.

In some embodiments, the processing system 2000 is configured to receive information through the I/O interface 2012. In some embodiments, the information received through the I/O interface 2012 includes, e.g., instructions, data such as scene data, set points, other parameters, or the like for processing by the processor 2002. In some embodiments, the information is transferred to the processor 2002 via the bus 2018. In some embodiments, the processing system 2000 is configured to receive information related to a user interface (UI) through the I/O interface 2012. In some embodiments, the information is stored in the computer-readable storage medium 2004 as a user interface (UI) 2010.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, one or more of the noted processes and/or methods is implemented as a software application that is a portion of a purpose-made tool. In some embodiments, a portion or all of the noted processes and/or methods is implemented as a software application that is used by the processing system 2000.

In some embodiments, the noted processes and/or methods are realized as functions of a program stored in a tangible, non-transitory computer-readable recording medium such as an external/removable and/or internal/built-in storage or memory unit, e.g., one or more of an optical disk, such as a DVD, a magnetic disk, such as a hard disk, a semiconductor memory, such as a ROM, a RAM, a memory card, or the like

One or more embodiments are implemented using hardware, code or instructions, or a combination thereof. One or more embodiments are implemented using hardware such as a processor. In some embodiments, the processor is a single dedicated processor, a single shared processor, or a plurality of dedicated and/or shared and/or parallel-processing processors. In some embodiments, the processor is, includes, or is included in a computer, a digital signal processor (DSP), a network processor, an application specific integrated circuit (ASIC), a field programmable gate array (FPGA), a combination of logic gates, hardware capable of executing software, a controller, a signal processing device, a combination thereof, or the like. In some embodiments, the processor includes or is coupled to a read only memory (ROM), a random access memory (RAM), a non volatile storage, a combination thereof, or the like. In some embodiments, other hardware is included. One or more embodiments are implemented using code or instructions to be executed by hardware, e.g., the above-described hardware. In some embodiments, the code or instructions include software, firmware, microcode, a combination thereof, or the like. In some embodiments, the code or instructions transform the hardware into a special-purpose processor for performing methods described herein. One or more embodiments is implemented in a non-transitory, tangible, machine-readable medium including executable instructions that, when executed by hardware, e.g., the above-described hardware, cause the hardware to perform methods described herein.

The method enables systematic design of passive reflector arrays tailored for high-accuracy vehicle localization on multi-track guideways. By defining boundaries of localization regions and determining the required number of distinct reflector arrays based on track configurations and vehicle orientations, the method ensures that the localization system is adaptable to complex guideway environments, including curved and sloped tracks.

Partitioning the three-dimensional bounding volume into a grid of potential reflector locations and generating candidate reflector arrays allows for efficient exploration of possible configurations within predefined spatial constraints. This ensures compact and feasible designs that meet operational requirements.

Filtering candidate reflector arrays based on radar resolution thresholds ensures that the selected arrays are detectable by imaging radar systems, avoiding configurations that would result in overlapping or indistinguishable radar returns. This step enhances the reliability of the localization system by ensuring persistent detectability of the reflector arrays.

Simulating detectability across test positions within the localization region accounts for real-world operational conditions, such as varying detection ranges and track geometries. This simulation step ensures that the reflector arrays remain resolvable with high confidence over consecutive test positions, improving robustness against environmental and sensor variations.

Evaluating robust distinctiveness by injecting radar measurement errors and reflector position perturbations ensures that the reflector arrays are distinguishable from one another even under adverse conditions. The use of a predefined Hamming distance threshold prevents false matches and ensures high-integrity localization.

Iteratively adjusting the bounding volume and maximum reflector count when the number of robustly distinct reflector arrays is insufficient ensures that the design process converges to a solution that meets the required number of distinct arrays. This iterative approach provides flexibility in adapting the design to meet operational needs.

The output of robustly distinct reflector arrays ensures that the localization system can reliably resolve vehicle positions with high accuracy, even in multi-track environments with potential occlusions or sensor errors. This enhances the safety and efficiency of rail operations, particularly in autonomous and safety-sensitive applications.

In a method aspect of designing a reflector array for high integrity localization, the method includes: defining a boundary of one or more localization regions; determining a number and location of unique reflector arrays; establishing a set of candidate reflector arrays; determining a subset of detectable reflector arrays of the candidate reflector arrays; verifying detectability over time of the subset of detectable reflector arrays; determining the subset of detectable reflector arrays that are robustly unique under sensor errors and/or reflector perturbations; and determining whether a sufficient number of detectable and unique reflector arrays have been established.

In an embodiment, the method further includes: outputting the number of detectable and unique reflector arrays.

In an embodiment, the method further includes: in response to determining that a sufficient number of detectable and unique reflector arrays have not been established, relaxing one or more requirements of the design and repeating the establishing a set of candidate reflector arrays, determining a subset of detectable reflector arrays, verifying detectability, determining the subset of detectable reflector arrays that are robustly unique, and determining whether a sufficient number of array have been established.

In an embodiment, the method further includes: wherein the establishing a set of candidate reflector arrays is performed based on a maximum volume of reflector arrays.

In an embodiment, the method further includes: wherein the establishing a set of candidate reflector arrays is performed based on a maximum number of reflectors.

In an embodiment, the method further includes: wherein the establishing a set of candidate reflector arrays is performed based on a maximum volume of reflector arrays and a maximum number of reflectors.

In an embodiment, the method further includes: wherein the verifying detectability is performed with respect to a guideway topology.

In an embodiment, the method further includes: wherein the sufficient number of detectable and unique reflector arrays is based on a required number of reflector arrays in a localization region and in an adjacent localization region.

In an embodiment, the method further includes: wherein the determining a number and location of unique reflector arrays is performed for each localization region.

In an embodiment, the method further includes: wherein the number of unique reflector arrays in a localization region is twice the number of parallel tracks in the localization region.

In an embodiment, the method further includes: wherein the number of unique reflector arrays in a localization region is established based on formula A: 2*(n−1) where n is the number of parallel tracks in the localization region.

In an embodiment, the method further includes: wherein the determining a subset of detectable reflector arrays includes:
establishing a candidate reflector array if the difference between longitudinal locations of two reflectors in the array is greater than a multiplication factor of the range resolution of a radar sensor.

In an embodiment, the method further includes: wherein the determining a subset of detectable reflector arrays includes: establishing a candidate reflector array if the difference between lateral locations of two reflectors in the array is greater than a multiplication factor of the azimuth resolution of a radar sensor.

In an embodiment, the method further includes: wherein the determining a subset of detectable reflector arrays includes: establishing a candidate reflector array if the difference between vertical locations of two reflectors in the array is greater than a multiplication factor of the elevation resolution of a radar sensor.

In an embodiment, the method further includes: wherein the verifying detectability over time includes: verifying a reflector array if each pair of reflectors in the array satisfies at least one of the following conditions: a difference between a range from a discrete location to the two reflectors is greater than a multiplication factor of the range resolution of a radar sensor; a difference between the azimuth angle from the discrete location to the two reflectors is greater than a multiplication factor of the azimuth resolution of the radar sensor; or a difference between an elevation angle from the discrete location to the two reflectors is greater than a multiplication factor of the elevation resolution of the radar sensor.

In an embodiment, the method further includes: wherein the determining the subset of detectable reflector arrays that are robustly unique includes: determining reflector arrays are unique if the number of matching reflectors having matching features in two reflector arrays is below a predetermined threshold.

In an embodiment, the method further includes: wherein the determining the subset of detectable reflector arrays that are robustly unique includes: determining reflector arrays are unique if the sensor range, azimuth angle, and/or elevation angle errors at different locations of the tracks for different reflectors in different reflector arrays are different.

In an embodiment, the method further includes: wherein the determining the subset of detectable reflector arrays that are robustly unique includes: determining reflector arrays are unique if the number of matching reflectors having matching features in two reflector arrays is below a predetermined threshold and if the sensor range, azimuth angle, and/or elevation angle errors at different locations of the tracks for different reflectors in different reflector arrays are different.

In a non-transitory computer-readable media aspect of designing a reflector array for high integrity localization, the non-transitory computer-readable media has computer-readable instructions stored thereon, which when executed by a processor causes the processor to perform operations including: defining a boundary of one or more localization regions; determining a number and location of unique reflector arrays; establishing a set of candidate reflector arrays; determining a subset of detectable reflector arrays of the candidate reflector arrays; verifying detectability over time of the subset of detectable reflector arrays; determining the subset of detectable reflector arrays that are robustly unique under sensor errors and/or reflector perturbations; and determining whether a sufficient number of detectable and unique reflector arrays have been established.

In an apparatus aspect for designing a reflector array for high integrity localization, the apparatus includes: a memory storing computer-readable instructions; and a processor connected to the memory, wherein the processor is configured to execute the computer-readable instructions to perform operations to: define a boundary of one or more localization regions; determine a number and location of unique reflector arrays; establish a set of candidate reflector arrays; determine a subset of detectable reflector arrays of the candidate reflector arrays; verify detectability over time of the subset of detectable reflector arrays; determine the subset of detectable reflector arrays that are robustly unique under sensor errors and/or reflector perturbations; and determine whether a sufficient number of detectable and unique reflector arrays have been established.

A method aspect of designing passive reflector arrays for vehicle localization on a multi-track guideway comprises defining boundaries of one or more localization regions corresponding to areas of the guideway requiring high-accuracy positioning; determining, for each localization region, a required number of distinct reflector arrays and associated candidate mounting locations based on a number of parallel tracks and on plausible vehicle orientations; partitioning a predefined three-dimensional bounding volume into a grid of potential reflector locations; generating a set of candidate reflector arrays by selecting reflector combinations up to a predefined maximum reflector count; filtering the set of candidate reflector arrays by rejecting any candidate reflector array having at least one pair of reflectors with longitudinal, lateral, or vertical separations below thresholds respectively derived from a range resolution, an azimuth resolution, or an elevation resolution of the imaging radar at a specified maximum detection range; simulating detectability of each remaining candidate reflector array by: emulating the multi-track segment topology, discretizing the one or more tracks into test positions between specified minimum and maximum detection ranges, and retaining only those candidate reflector arrays for which all reflectors are resolvable from each test position according to the radar resolutions with at least a predetermined confidence over a plurality of consecutive test positions; evaluating robust distinctiveness of the retained reflector arrays by: injecting modeled imaging radar measurement errors and incremental reflector position perturbations across multiple simulated test positions, and rejecting any reflector array that matches at least a predefined minimum number of reflectors with any other retained reflector array as determined by a predetermined Hamming distance threshold; comparing a number of the robustly distinct reflector arrays to the required number and, when the number of robustly distinct reflector arrays is less than the required number, adjusting at least one of the predefined bounding volume and the predefined maximum reflector count and repeating the partitioning, filtering, simulating, and evaluating steps; and outputting all robustly distinct reflector arrays when the number of robustly distinct reflector arrays meets or exceeds the required number.

A computer-implemented method aspect for determining a precise position of a rail vehicle traveling on a guideway comprises emitting, by an imaging radar mounted on the rail vehicle, a radio-frequency imaging signal toward trackside infrastructure; receiving echoes of the imaging signal and forming, from the echoes, a three-dimensional radar point-cloud comprising a plurality of point returns; identifying within the point-cloud a cluster of point returns that matches a predefined three-dimensional spatial pattern of a passive reflector array that is rigidly fixed with respect to the guideway; using Doppler information derived from the echoes to verify that the identified cluster is stationary relative to the ground; and correlating the verified cluster with georeferenced map data storing coordinates of the passive reflector array to compute a precise position of the rail vehicle.

The method further comprises discarding, prior to the identifying, point returns having Doppler velocities exceeding a threshold, thereby suppressing returns from moving objects.

The method also includes, wherein the identifying comprises: pattern matching that tolerates absence of a single reflector return within the cluster without loss of correct identification of the passive reflector array.

The method further comprises determining a heading of the rail vehicle by comparing lateral offsets of the identified cluster within the point-cloud to the stored georeferenced coordinates.

The method also includes, wherein the predefined spatial pattern corresponds to: at least four trihedral corner reflectors mounted within an envelope not exceeding about 1 m×0.6 m×1 m.

The method further comprises: calculating an integrity metric for the computed precise position based on at least one of: the number of reflector returns matched; residual errors of the correlation; and consistency between range-based and angle-based sub-estimates of position.

A passive reflector landmark aspect for railway vehicle localization comprises: a structural frame occupying a volume not greater than about 1 m×0.6 m×1 m and supporting a three-dimensional arrangement of at least four radar reflectors positioned at mutually different longitudinal, lateral, and vertical offsets such that inter-reflector spacings collectively define a distinct spatial signature that remains distinguishable relative to all other landmarks of a plurality of landmarks when any single reflector is occluded or missing, the spatial signature being machine-detectable by an imaging radar onboard a passing rail vehicle over a predefined detection range.

The passive reflector landmark also includes wherein each radar reflector is: a trihedral corner reflector having electrically conductive interior surfaces.

The passive reflector landmark also includes wherein for each pair of radar reflectors in the arrangement at least one of the following relationships is satisfied: a difference in range from the imaging radar, at a maximum design detection distance, that exceeds a predetermined multiple of a range resolution of the imaging radar; a difference in azimuth angle, at the maximum design detection distance, that exceeds a predetermined multiple of an azimuth angular resolution of the imaging radar; or a difference in elevation angle, at the maximum design detection distance, that exceeds a predetermined multiple of an elevation angular resolution of the imaging radar.

The passive reflector landmark also includes wherein the at least four radar reflectors are arranged to provide: a Hamming distance of at least three relative to any other landmark of the plurality of landmarks.

A computer-implemented method aspect for designing a passive reflector array for high-integrity railway localization comprises: defining a permissible installation volume and a maximum number of radar reflectors; generating a candidate set of reflector positions on a three-dimensional grid within the permissible volume; simulating imaging-radar observations of each candidate set under multiple sensor error models and reflector perturbations while propagating the rail vehicle along modeled tracks; evaluating, for each simulation, whether all reflectors of the candidate set are detectable over a specified detection range and whether the resulting spatial pattern is distinguishable from all other candidate sets and from modeled natural trackside objects; and outputting the candidate set as a reflector array design only when a probability of similarity determined from the simulations is below a predefined threshold.

One or more of the other approaches exhibit some or all of the following problems:
Need for dense installation of landmark objects: This is a drawback of traditional localization techniques based on transponders or UWB, as previously mentioned. In particular, those technologies require dense installation of passive landmarks either on the tracks (e.g. radio frequency identification (RFID) transponder tags), or dense installation of active landmarks (e.g. UWB anchors) in designated areas such as platforms, switches or signals. These landmarks require installation effort and maintenance effort which may influence revenue operation due to the need to close track section or section for the landmark installation and maintenance. Active landmarks are typically disliked by user because it may require additional maintenance and installation effort such as providing power to the landmarks.
Lack of integrity: The aforementioned scene-based positioning approaches do not address or claim high integrity design of the localization system, which is key for safety-critical rail applications. The are other approaches which claim integrity using a probabilistic framework, namely a protection limit argument of position hypotheses. However, this probabilistic framework is not suitable for addressing systematic errors (e.g., non-modelled sensor bias, train motion model limitations) or addressing limitations of sensor technologies (e.g., scene & environmental effects) which are extremely difficult to model probabilistically. Also, the protection limit arguments typically suffer from having non-justifiable assumptions on error distributions (e.g., Gaussian error) and non-justifiable selection of some parameters (e.g., a priori fault probability). Other approaches do not propose a safe architecture utilizing multi-sensor diversity, algorithmic diversity, safety supervisions or interpretable features for matching which are all characteristics of high-integrity systems for SIL 4 certification. For at least these reasons, the certification of these probabilistic filters in the rail domain is challenging, and our approach aims to avoid these probabilistic approaches (i.e., avoid argument based on protection limit algorithms).
Lack of interpretable matching features: Some of the aforementioned approaches lack the use of interpretable matching features, and hence, it is difficult to justify the use of those matching methods in safety-critical application. For example, another approach compares entire images using automated feature extraction and computer vision algorithms, and hence, one cannot explain in a way understandable by human what are the object features used in the matching decision and hence in localization. Similar concern applies to another approach comparing detected scene to previous stored images of experiences. Indeed, most other relevant approaches do not explicitly consider rail vehicles application, and hence, the defined features in those approaches are not designated for rail environment. An example of specific landmark object for rail environment is platform edge, and an example of contextual feature for rail environment is the association between the landmark objects and the train track/path.
Lack of a verification method for robust uniqueness of constellation of landmarks: None of the aforementioned relevant approaches provides a method for verifying robust uniqueness of constellation of landmarks, i.e., verifying uniqueness of constellation of landmarks under various perturbations (e.g., sensor measurement errors, false detections, misdetections, and occlusion). Indeed, the approaches do not even touch on how to verify uniqueness of natural landmark objects in the scene under ideal conditions. As a result, none of those relevant approaches provides a method for determining the needed number and location of additional for-purpose landmark objects to satisfy robust uniqueness conditions and hence high-integrity localization. Note that one other approach discusses robustness in a very different context, particularly assessing the scenario of the environment (e.g., vehicle speed, road type, road speed) and expected degree of robustness of localization for determined scenario and then adapting/controlling one or more parameters of the scenario (e.g., sensor detection ranges, no. of landmark objects used for localization) to end up in ascertained localization scenario. Another approach does not discuss uniqueness of constellations of landmarks under perturbations or integrity. Also, note that another approach provided a method for adding landmarks in a different context, particularly assessing the effect of adding landmarks in a geographical region on position accuracy in resolving the localization problem in this region. Nevertheless, the other approach does not consider robust uniqueness of constellation of landmarks or how to verify this property to determine the needed for-purpose landmarks for achieving high-integrity localization.
Lack of temporal tracking of scene features: Many of the relevant approaches lack temporal tracking of scene features which is key for robustness against false detections and for handling the case where the distinct scene features for localization are extended geographically over a distance longer than the sensor FOV.
Non-robustness against scene variations and environmental conditions: Relevant methods relying on storing entire images/experiences in database will be strongly tied to the conditions under which those images are captured, and hence, they will not be robust to change in scene or environmental conditions (e.g., weather or lighting conditions). While one other approach tries to fix this problem by storing various images of all previous experiences, this may not be enough to capture all the possible variations of the scene and environment conditions which may be non-feasible. Also, the relevant methods relying on one sensor technology are expected to be non-robust as they are limited to the sensing limitations of those technologies.
Difficulty of maintaining/updating the database: Some of the relevant methods rely on saving entire images captured at each location instead of modular information of landmark objects. Hence, a simple update to one of the landmark objects (e.g., location of a sign) will require re-capturing the entire images of the corresponding region in the database, which is a lengthy & expensive process.

At least one or more of the following characteristics are considered novel and inventive:
1. A novel 3D passive reflector array design based on a systematic methodology for ensuring compact size within a predefined maximum volume, detectability of the reflector array with confidence by the imaging radar over the detection range of interest, and uniqueness of the reflector array even under detection errors and/or failures.
2. A novel methodology for verifying the detectability of all reflectors in the reflector array from different intended tracks and over the detection range of interest; the methodology is based on a designed simulation environment of multi-track segment and it is valid for curved and/or sloppy track segments of the guideway.
3. A novel methodology for verifying the uniqueness of the reflector array over the position search region even under sensor detection errors or failures/changes of the array.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of designing a reflector array for high integrity localization, the method comprising:
defining a boundary of one or more localization regions;
determining a number and location of unique reflector arrays;
establishing a set of candidate reflector arrays;
determining a subset of detectable reflector arrays of the candidate reflector arrays;
verifying detectability over time of the subset of detectable reflector arrays;
determining the subset of detectable reflector arrays that are robustly unique under sensor errors and/or reflector perturbations; and
determining whether a sufficient number of detectable and unique reflector arrays have been established.

2. The method of claim 1, further comprising:
outputting the number of detectable and unique reflector arrays.

3. The method of claim 1, further comprising:
in response to determining that a sufficient number of detectable and unique reflector arrays have not been established, relaxing one or more requirements of the design and repeating the establishing a set of candidate reflector arrays, determining a subset of detectable reflector arrays, verifying detectability, determining the subset of detectable reflector arrays that are robustly unique, and determining whether a sufficient number of array have been established.

4. The method of claim 1, wherein the establishing a set of candidate reflector arrays is performed based on a maximum volume of reflector arrays.

5. The method of claim 1, wherein the establishing a set of candidate reflector arrays is performed based on a maximum number of reflectors.

6. The method of claim 1, wherein the establishing a set of candidate reflector arrays is performed based on a maximum volume of reflector arrays and a maximum number of reflectors.

7. The method of claim 1, wherein the verifying detectability is performed with respect to a guideway topology.

8. The method of claim 1, wherein the sufficient number of detectable and unique reflector arrays is based on a required number of reflector arrays in a localization region and in an adjacent localization region.

9. The method of claim 1, wherein the determining a number and location of unique reflector arrays is performed for each localization region.

10. The method of claim 1, wherein the number of unique reflector arrays in a localization region is twice the number of parallel tracks in the localization region.

11. The method of claim 1, wherein the number of unique reflector arrays in a localization region is established based on formula A:
$$2 * ( n - 1 )$$
where n is the number of parallel tracks in the localization region.

12. The method of claim 1, wherein the determining a subset of detectable reflector arrays comprises:
establishing a candidate reflector array if the difference between longitudinal locations of two reflectors in the array is greater than a multiplication factor of the range resolution of a radar sensor.

13. The method of claim 1, wherein the determining a subset of detectable reflector arrays comprises:
establishing a candidate reflector array if the difference between lateral locations of two reflectors in the array is greater than a multiplication factor of the azimuth resolution of a radar sensor.

14. The method of claim 1, wherein the determining a subset of detectable reflector arrays comprises:
establishing a candidate reflector array if the difference between vertical locations of two reflectors in the array is greater than a multiplication factor of the elevation resolution of a radar sensor.

15. The method of claim 1, wherein the verifying detectability over time comprises:
verifying a reflector array if each pair of reflectors in the array satisfies at least one of the following conditions:
a difference between a range from a discrete location to the two reflectors is greater than a multiplication factor of the range resolution of a radar sensor;
a difference between the azimuth angle from the discrete location to the two reflectors is greater than a multiplication factor of the azimuth resolution of the radar sensor; or
a difference between an elevation angle from the discrete location to the two reflectors is greater than a multiplication factor of the elevation resolution of the radar sensor.

16. The method of claim 1, wherein the determining the subset of detectable reflector arrays that are robustly unique comprises:
determining reflector arrays are unique if the number of matching reflectors having matching features in two reflector arrays is below a predetermined threshold.

17. The method of claim 1, wherein the determining the subset of detectable reflector arrays that are robustly unique comprises:
determining reflector arrays are unique if the sensor range, azimuth angle, and/or elevation angle errors at different locations of the tracks for different reflectors in different reflector arrays are different.

18. The method of claim 1, wherein the determining the subset of detectable reflector arrays that are robustly unique comprises:
determining reflector arrays are unique if the number of matching reflectors having matching features in two reflector arrays is below a predetermined threshold and if the sensor range, azimuth angle, and/or elevation angle errors at different locations of the tracks for different reflectors in different reflector arrays are different.

19. A non-transitory computer-readable media having computer-readable instructions stored thereon, which when executed by a processor causes the processor to perform operations comprising:
defining a boundary of one or more localization regions;
determining a number and location of unique reflector arrays;
establishing a set of candidate reflector arrays;
determining a subset of detectable reflector arrays of the candidate reflector arrays;
verifying detectability over time of the subset of detectable reflector arrays;
determining the subset of detectable reflector arrays that are robustly unique under sensor errors and/or reflector perturbations; and
determining whether a sufficient number of detectable and unique reflector arrays have been established.

20. An apparatus for designing a reflector array for high integrity localization, comprising:
a memory storing computer-readable instructions; and
a processor connected to the memory, wherein the processor is configured to execute the computer-readable instructions to perform operations to:
define a boundary of one or more localization regions;
determine a number and location of unique reflector arrays;
establish a set of candidate reflector arrays;
determine a subset of detectable reflector arrays of the candidate reflector arrays;
verify detectability over time of the subset of detectable reflector arrays;
determine the subset of detectable reflector arrays that are robustly unique under sensor errors and/or reflector perturbations; and
determine whether a sufficient number of detectable and unique reflector arrays have been established.
